(19) United States
(12) Patent Application Publication
(10) Pub. No.: US 2014/0312745 A1
(43) Pub. Date: Oct. 23, 2014

(54) Electric Motor

(71) Applicant: AeroVironment, Inc., Monrovia, CA (US)

(72) Inventors: William Nicoloff, Camarillo, CA (US); QinZhong Yu, Arcadia, CA (US)

(21) Appl. No.: 14/179,428

(22) Filed: Feb. 12, 2014

Related U.S. Application Data
(63) Continuation of application No. PCT/US12/50445, filed on Aug. 10, 2012.
(60) Provisional application No. 61/523,207, filed on Aug. 12, 2011.

(51) Int. Cl. H02K 1/17; H02K 7/14

(52) U.S. Cl. CPC H02K 1/17; H02K 7/14
USPC 310/67 R; 310/154.21

(57) ABSTRACT

An asymmetric brushless direct current (DC) motor having a stator having a plurality of magnets and a rotor having a plurality of armatures where the vector sum of magnetic forces between each armature and each respective magnet is zero at every angular rotation position of the rotor with respect to the stator in the motor's non-energized state.

### CROSS REFERENCE TO RELATED APPLICATIONS

This application is a continuation of International Patent Application No. PCT/US12/50445, filed Aug. 10, 2012, which claims priority to and the benefit of U.S. Provisional Application No. 61/523,207, filed Aug. 12, 2011, both of which are hereby incorporated by reference herein for all purposes.

### TECHNICAL FIELD OF ENDEAVOR

The field of the invention relates to direct current (DC) motors, and more particularly to asymmetric brushless DC motors.

### BACKGROUND

Direct current (DC) brushless motors may be used to drive motor shafts, such as a motor shaft driving a propeller on an unmanned aerial vehicle (UAV). In applications that require driving slower-moving components, such as an imager that may pan about the UAV to provide real-time video of the environment, a sensor gimbal having reduction gears may be used between the rotatable shaft of the motor and the imager. Unfortunately, the gimbal assembly may not allow the imager to move when the imager is subject to a ground strike during landing; thereby increasing the peak stresses experienced by the reduction gears and imager during some UAV sorties.

A need continues to exist for power efficient and DC motors used in combination with shock tolerant sensor gimbals.

### SUMMARY

Embodiments of the invention include a DC motor apparatus, comprising a stator having a plurality of magnets; and a rotor having a plurality of armatures, where a quantity of the plurality of armatures may be less than a quantity of the plurality of magnets, each of the armatures of the plurality of armatures experiencing a vector magnetic force in response to its proximity to respective adjacent magnets of the plurality of magnets, and each of the armatures having a planar sidewall opposing a planar sidewall of an adjacent armature; where the vector sum of magnetic forces between each armature and its respective adjacent magnets of the plurality of magnets may be zero at every angular rotation position of the rotor with respect to the stator in the motor's non-energized state. In additional exemplary apparatus embodiments each armature of the plurality of armatures may comprise a forward-tapered end and an aft-tapered end, where each of the forward-tapered ends and each of the aft-tapered ends may be configured to accept periodic near magnetic saturation as the armature rotates past the respective adjacent magnets of the plurality of magnets. In additional exemplary apparatus embodiments each armature of the plurality of armatures may have a constant-radius face. In additional exemplary apparatus embodiments each magnet of the respective adjacent magnets of the plurality of magnets may have a planar face in complementary opposition to the constant-radius face of each armature of the plurality of armatures. In additional exemplary apparatus embodiments the stator may have between thirteen and nineteen magnets and the rotor may have between twelve and eighteen armatures. In additional exemplary apparatus embodiments each armature of the plurality of armatures may have a complementary face to each magnet of the respective adjacent magnets of the plurality of magnets, each complementary face selected from the group consisting of multi-planar, concave, and convex. In additional exemplary apparatus embodiments each armature of the plurality of armatures may have a tapered root section. In additional exemplary apparatus embodiments the stator may further comprise a back iron. In additional exemplary apparatus embodiments the back iron may have inner angular sidewall portions to align each magnet of the plurality of magnets. In additional exemplary apparatus embodiments each magnet of the plurality of magnets may be an electromagnet. In additional exemplary apparatus embodiments each armature of the plurality of armatures may be comprised of alternating layers of a laminated electrical steel layer and an oxide film layer.

Other apparatus embodiments include a DC motor, comprising a stator having a plurality of armatures, each of the armatures having a planar sidewall opposing a planar sidewall of an adjacent armature, and; a rotor having a plurality of magnets, each of the magnets of the plurality of magnets experiencing a vector magnetic force in response to its proximity to respective adjacent armatures of the plurality of armatures, where a quantity of the plurality of magnets is less than a quantity of the plurality of armatures; and where the vector sum of magnetic forces between each magnet and its respective adjacent armatures of the plurality of armatures is zero at every angular rotation position of rotor the with respect to the stator in the non-energized state of the motor. In additional exemplary apparatus embodiments each armature of the plurality of armatures may comprise a forward-tapered end and an aft-tapered end, where each of the forward-tapered ends and each of the aft-tapered ends may be configured to accept periodic near magnetic saturation as the magnets rotate past the respective adjacent armature of the plurality of armatures. In additional exemplary apparatus embodiments each armature of the plurality of armatures may have a constant-radius face. In additional exemplary apparatus embodiments each magnet of the respective adjacent magnets of the plurality of magnets may have a planar face in complementary opposition to the constant-radius face of each armature of the plurality of armatures. In additional exemplary apparatus embodiments the stator may have between thirteen and nineteen armatures and the rotor may have between twelve and eighteen magnets. In additional exemplary apparatus embodiments each armature of the plurality of armatures may have a complementary face to each magnet of the respective adjacent magnets of the plurality of magnets, each complementary face selected from the group consisting of multi-planar, concave, and convex. In additional exemplary apparatus embodiments each armature of the plurality of armatures may have a tapered root section. In additional exemplary apparatus embodiments the stator may further comprise a back iron. In additional exemplary apparatus embodiments the back iron may have inner angular sidewall portions to align each magnet of the plurality of magnets. In additional exemplary apparatus embodiments each magnet of the plurality of magnets may be an electromagnet. In additional exemplary apparatus embodiments each armature of the plurality of armatures may be comprised of alternating layers of a laminated electrical steel layer and an oxide film layer. In one embodiment, a motor shaft may be driven by the rotor, and a sensor rotatably driven by the motor shaft so that the zero vector sum of magnetic forces between each magnet and its respective adjacent armatures results in a “cogless” rotation of the sensor on the motor shaft.

Embodiments may also include a motor method comprising communicating a plurality of magnetic fields between a respective plurality of armatures on a rotor and respective pairs of magnets on a stator for each armature; and balancing the plurality of magnetic fields about the rotor as the rotor is rotated so that the vector sum of magnetic forces on the plurality of armatures may be approximately zero as the rotor is rotated a complete revolution in its non-energized state; where the motor may be substantially “cogless” as the rotor turns in its non-energized state.

Embodiments may also include an unmanned aerial vehicle (UAV) sensor apparatus, comprising a UAV, a brushless direct current (DC) motor coupled to the UAV, the DC motor further comprising a stator having a plurality of magnets, and a rotor having a plurality of armatures, where a quantity of the plurality of armatures is less than a quantity of the plurality of magnets, each of the armatures of the plurality of armatures experiencing a vector magnetic force in response to its proximity to respective adjacent magnets of the plurality of magnets, and each of the armatures having a planar sidewall opposing a planar sidewall of an adjacent armature, where the vector sum of magnetic forces between each armature and its respective adjacent magnets of the plurality of magnets is zero at every angular rotation position of the rotor with respect to the stator in the motor's non-energized state, and a sensor coupled to the motor in a direct-drive configuration, where the sensor is driven directly by the motor so that an angular rotation of the rotatable shaft, Δφ, results in the same angular rotation Δφ of the sensor. In additional exemplary apparatus embodiments, each armature of the plurality of armatures may comprise a forward-tapered end and an aft-tapered end, where each of the forward-tapered ends and each of the aft-tapered ends are configured to accept periodic near magnetic saturation as the armature rotates past the respective adjacent magnets of the plurality of magnets. In additional exemplary apparatus embodiments, each armature of the plurality of armatures may have a face shape selected from the group consisting of multi-planar, concave, and convex.

Embodiments may also include an unmanned aerial vehicle (UAV) sensor apparatus, comprising a UAV, a direct-drive motor coupled to the UAV, and a sensor coupled to the direct-drive motor, the direct-drive motor configured to angularly drive the sensor. In such an embodiment, the direct-drive motor may be coupled to the UAV through a support.

### BRIEF DESCRIPTION OF THE DRAWINGS

Embodiments are illustrated by way of example and not limitation in the figures of the accompanying drawing, and in which:

FIG. 1 is a cross sectional perspective view illustrating one embodiment of a DC motor having tapered rotor armature heads facing respective stator magnets;

FIG. 2 is a cross sectional plan view illustrating the DC motor of FIG. 1 along the line 2-2;

FIG. 3 is an expanded plan view illustrating the DC motor of FIG. 2 at the dashed line;

FIG. 4 is a perspective view of the DC motor illustrated in FIG. 3;

FIG. 5 is a top plan view of a plurality of coils wound around a respective plurality of armatures;

FIG. 6 is a top plan view illustrating a rotor having coils wound around respective tapered armatures;

FIG. 7 is a cross sectional plan view illustrating one embodiment of a DC motor having tapered stator armature heads facing respective rotor magnets;

FIG. 8 is a cross sectional plan view illustrating one embodiment of an in-line DC motor having linear rotor stator armature heads facing respective stator magnets;

FIG. 9 is a perspective view of an unmanned aerial vehicle (UAV) with an exemplary sensor gimbal;

FIG. 10 is a side view of a UAV with an exemplary sensor gimbal approaching the ground; and

FIG. 11 is a side view of a UAV with an exemplary sensor gimbal making contact with the ground.

### DETAILED DESCRIPTION

A DC motor is disclosed that has an improved rotor and stator design, with rotor armatures that collectively provide a vector sum magnetic force (F_{V})_{SUM} of zero at every angular rotation position of the rotor with respect to the stator during the rotor's non-energized state to reduce magnetic “cogging.” In applications that require reduced system vibration, such as in UAVs that use image sensors operable to pan about the UAV, such “cogless” motors ease vibration design constraints and may produce better image data. Such “cogless” and gearless designs also result in a more robust and shock-tolerant design when used to directly drive such image sensors, as the lack of gears allows the image sensors to rotate in response to shocks to reduce peak stresses experienced by the sensors.

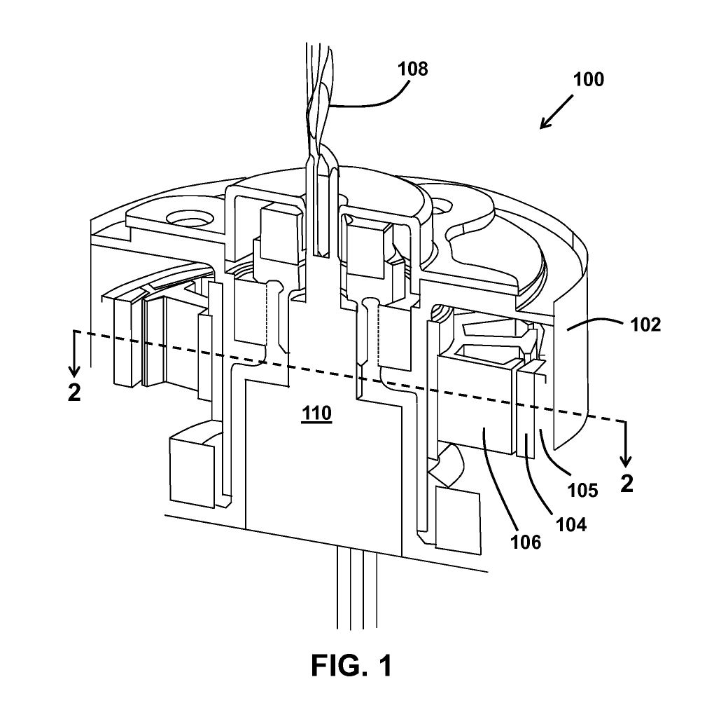

FIG. 1 illustrates a brushless DC motor in a conventional configuration that includes an in-runner rotor electrically connected with a wye-configuration winding about improved armatures. The DC motor 100 may have a casing 102 formed of steel or other high-strength material to enclose and protect the motor 100. A stator 104 is positioned around the perimeter of a rotor 106, with the stator having a back iron 105 to extend the magnetic field of the stator 104. The stator 104 may be formed of permanent magnets such as neodymium and praseodymium or suitable magnet, including electromagnets. The rotor 106 may have armatures built up from layers of laminated electrical steel, such as silicon steel, with an oxide film positioned between each steel layer, to reduce induced ring currents and to increase efficiency of the motor. Other armature materials may include iron or amorphous steel. Power and signal cabling 108 extend through a donut hole 110 in the DC motor 100.

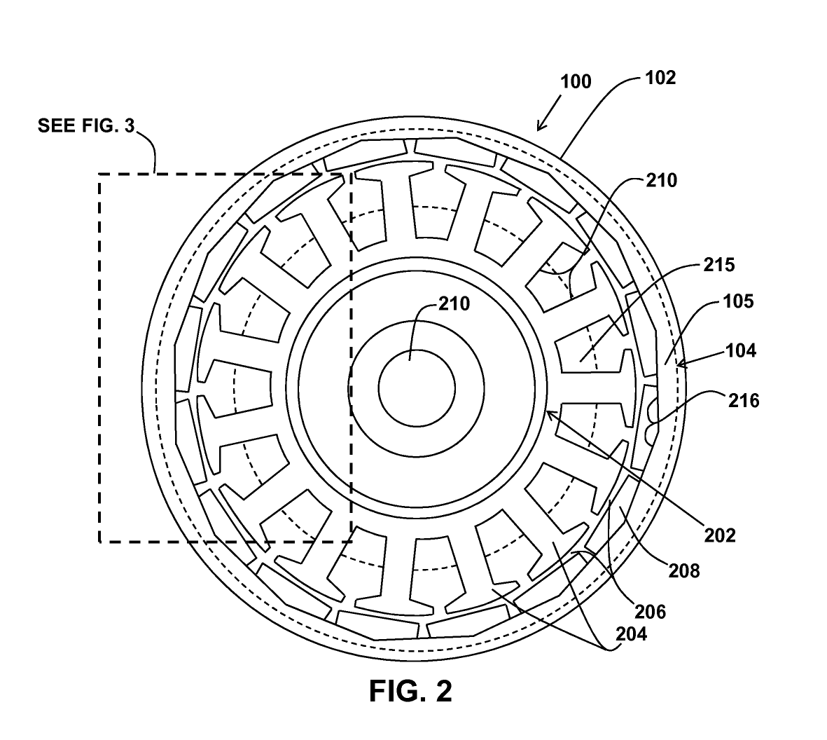

FIG. 2 is a cross sectional top plan view of the DC motor illustrated in FIG. 1 along the lines 2-2. In the exemplary embodiment illustrated in FIG. 2, there are more stator poles, e.g., permanent magnets, than rotor armatures 204. The rotor 202 may have at least thirteen armatures 204, with fifteen armatures in the illustrated embodiment of FIG. 2. The stator may have at least fourteen permanent magnets 208, with sixteen permanent magnets 208 in the illustrated embodiment. A minimum air gap 206 is maintained between each armature 204 and a respective magnet 208 as the armature 204 travels past a magnet 208 during operation. The minimum air gap 206 may be reduced to a distance approaching assembly tolerances of the motor to prohibit physical contact of the rotor and stator while increasing torque of the motor with closer placement of the stator and rotor. Opposing walls 210 of adjacent armatures 204 may each be planar and oriented perpendicular to an axis of rotation of the rotor 202. Field coils 215, the field coil area indicated by dashed lines, may be formed of copper wiring to provide excitation of each armature 202. The back iron 105 may have inner angular sidewall portions 216 to seat respective magnets 208 to accomplish better alignment verses a purely cylindrical surface. A motor shaft (not shown) may be driven by the rotor 202 to rotatably drive a propeller, sensor or other component.

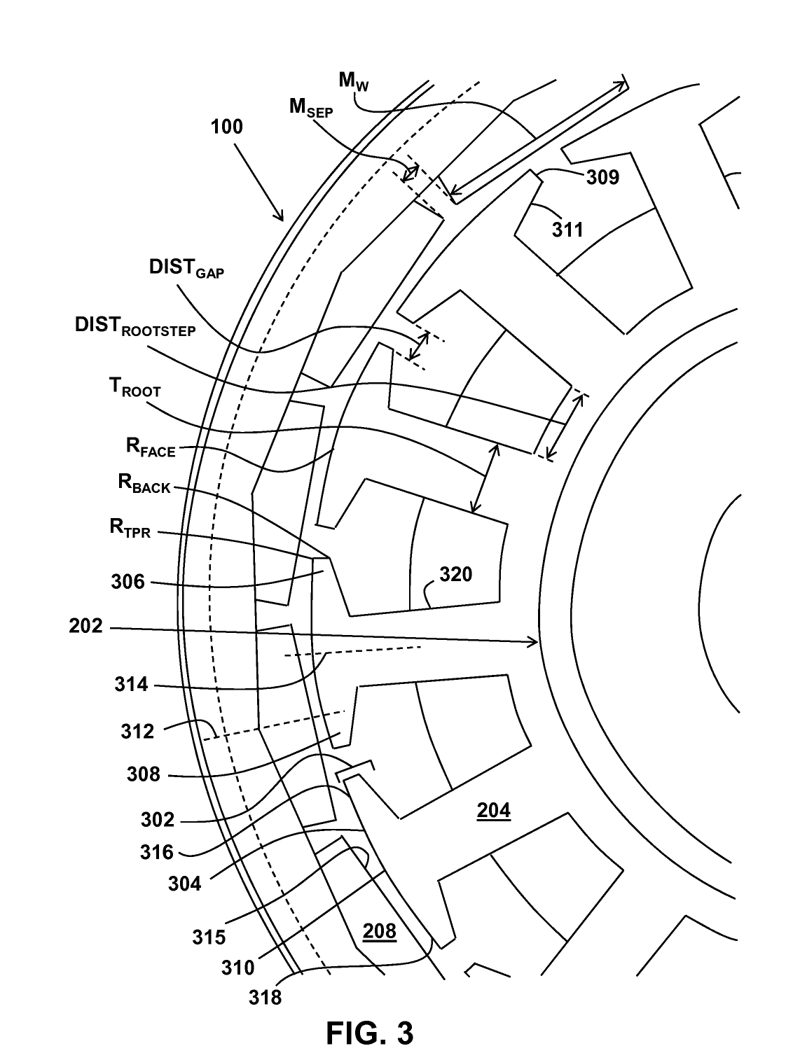

FIG. 3 is a plan view expanding the area indicated in FIG. 2 with dashed lines, to better illustrate the rotor and stator. Each armature 204 has a head portion 302 that may consist of a face 304 and forward-tapered and aft-tapered ends 306,308, with the forward-tapered and aft-tapered ends 306,308 having a transitional radius of curvature (R_{TPR}) from the face 304 to a side surface 309 of the head 302. Transition from the side surface 309 to a back surface 311 may have a radius of curvature (R_{BACK}). The thickness profile of the forward-tapered and aft-tapered ends (306, 308) is minimized to enable greater winding material about each armature root 320 while avoiding field-line saturation of the material of the forward-tapered and aft-tapered ends (306, 308). Each head portion 302 may be separated from the adjacent head portion by a gap distance (DIST_{GAP}). Although described in terms of “forward” and “aft,” the motor 100 is configured to rotate the rotor 202 in either clockwise or counterclockwise angular directions, and so the forward-tapered and aft-tapered ends (306, 308) may be similarly shaped. The root 320 of each armature 204 may have a thickness (T_{ROOT}), and each root 320 may be spaced from an adjacent root 320 at their distal ends with a separation distance (DIST_{ROOTSTEP}).

As illustrated in FIG. 3, the face 304 may have a constant radius surface curvature (R_{FACE}). In such an embodiment, the magnets 208 may have a face 315 that that is substantially flat with a length M_{W} and a separation distance between magnets at the face side of M_{SEP}. In an alternative embodiment, the face 304 may have a multi-planar, convex, concave or other-shaped surface to interact with opposing and complementary faces of the stator (not shown). In an embodiment having a center planar surface 310 on each face 304, the center planar surface 310 may extend perpendicular to the radius of rotation of the rotor 202 so that the center planar surface 310 forms a parallel surface to the face 315 of each respective magnet 208 that is planar when the centers of the magnet 208 and armature (312, 314), indicated by dashed lines, are aligned. Forward and aft planar surfaces (316, 318) may sweep back from the center planar region 310 to expand the total surface area of the head portion 302 verses a cross section surface area of a root 320 of the armature 204.

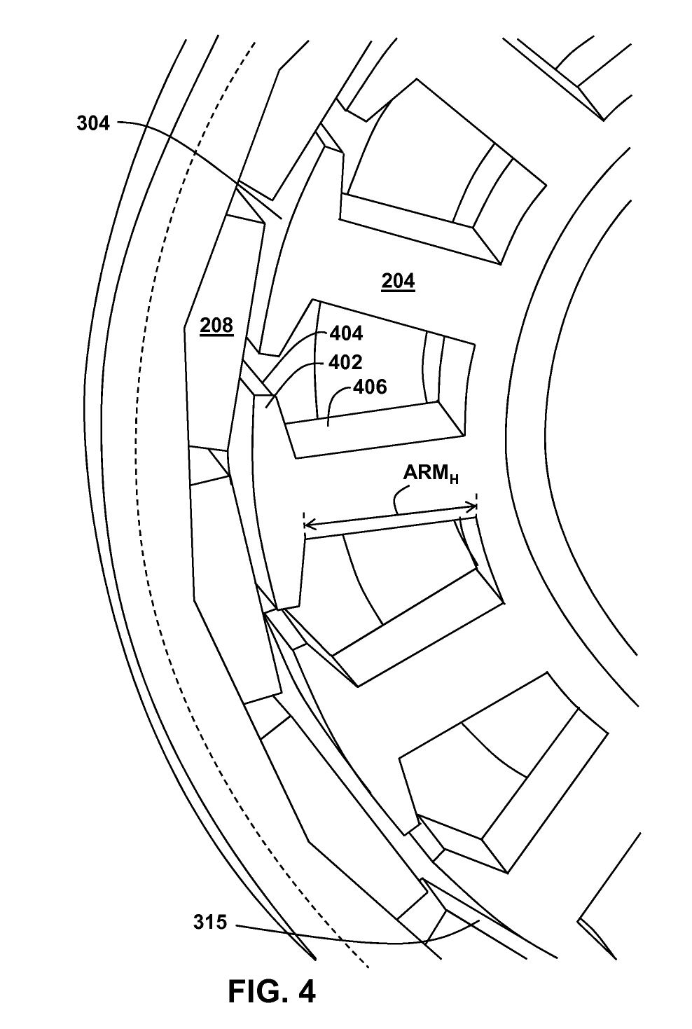

In one embodiment illustrated in FIG. 4, the forward tapered end 402 may be formed of a plurality of planar sections 404. In an alternative embodiment, the forward tapered end 402 may be curved. Each armature 406 may have a height (ARM_{H}) of approximately 5.588 millimeters. If greater motor torque is desired, the height (ARM_{H}) may be increased. Similarly, if less motor torque is desired, the height (ARM_{H}) may be decreased.

In one implementation of a motor designed for a rotor having fifteen armatures and sixteen magnets, the various components may have the dimensions listed in the exemplary Table 1.

TABLE 1

| | | |
|---|---|---|
| R_{TPR} | 0.127 | mm |
| R_{BACK} | 0.127 | mm |
| DIST_{GAP} | 0.7874 | mm |
| R_{FACE} | 26.8732 | mm |
| T_{ROOT} | 1.8034 | mm |
| DIST_{ROOTSEP} | 1.7272 | mm |
| M_{W} | 4.99999 | mm |
| M_{SEP} | 0.50673 | mm |

During operation, and in the motor's non-energized state, each armature 204 experiences a vector magnetic force (F_{V}) in response to its proximity to respective adjacent magnets 208. As a result of the dimensions and location of every armature face 304 in relation to complementary adjacent magnet faces 315, the vector sum of all armature magnetic forces (F_{V})_{SUM} is zero at every angular rotation position of the rotor with respect to the stator to substantially reduce magnetic “cogging” as the rotor experiences non-energized rotation.

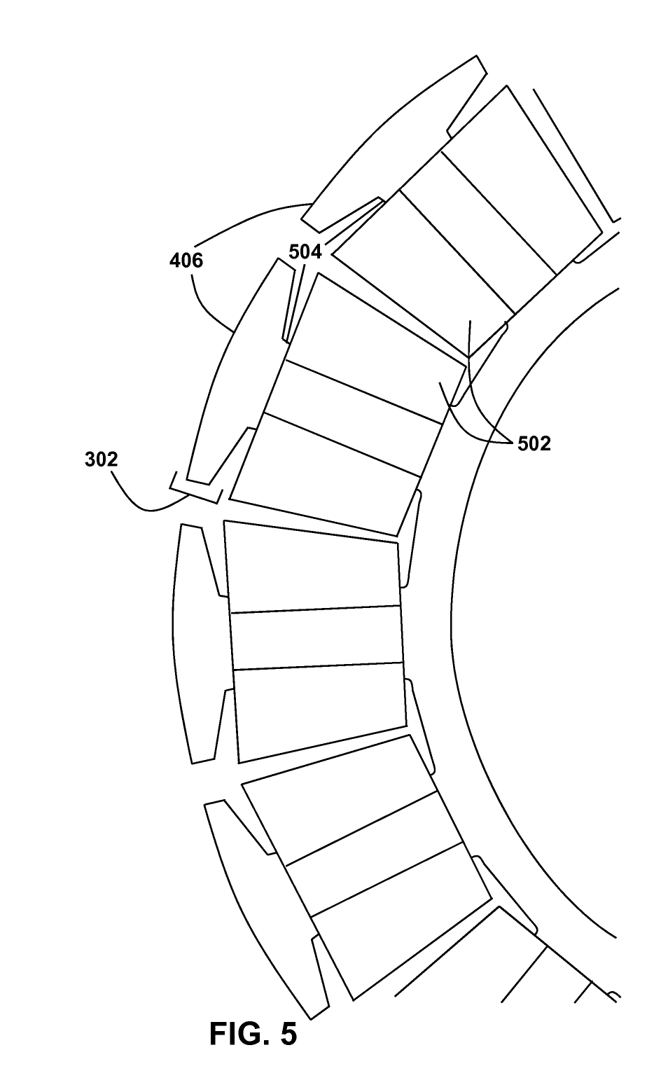

FIG. 5 is a top plan view of a portion of one embodiment of a rotor having a coil extending around the armatures first illustrated in FIGS. 3 and 4. Each armature 406 may have a coil 502 wrapped around its root section 504 to provide its excitation. In one embodiment designed for 3-phase operation and 250 VAC at 60 HZ, each coil may be formed of small-gauge copper wire, e.g., 28 gauge wire wrapped approximately 48 turns about the armature's root section 504, and insulated with two layers of Kapton® tape (not shown), offered by DuPont of Wilmington, Del., for insulation. Each coil may be wrapped having progressively more turns as the root section 504 approaches the head portion 302 to enable a greater number of windings per armature without impinging on an adjacent winding.

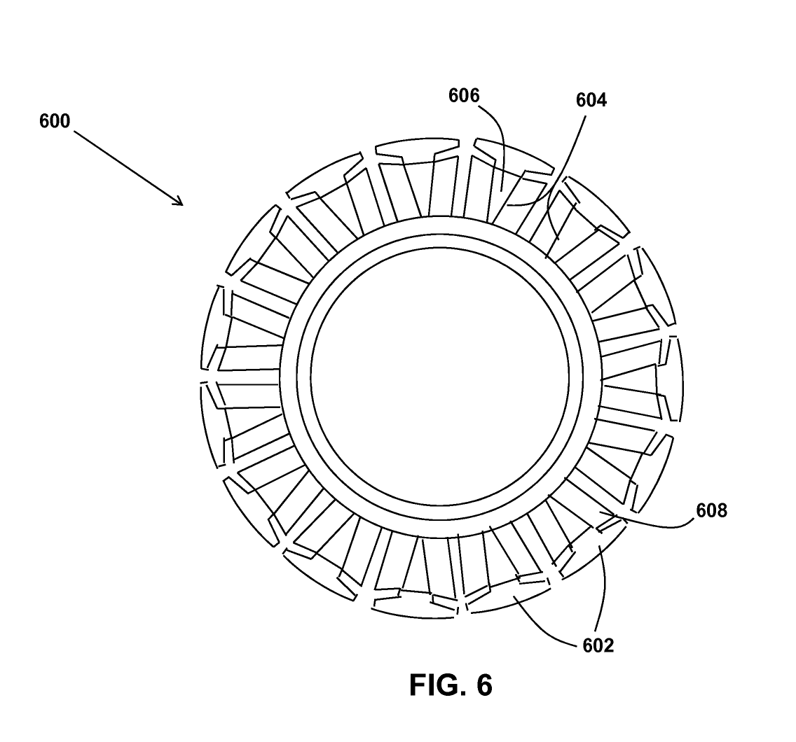

FIG. 6 illustrates an alternative embodiment of a rotor having a constant radius face on each tapered armature. The rotor 600 may have approximately at least thirteen armatures 602, with fifteen armatures in the illustrated embodiment of FIG. 6. Opposing sidewalls 604 of adjacent armatures 602 may each be planar and approximately parallel to one another to define a tapered root section 606 for each armature 602 to enable greater copper coiling verses non-tapered root sections. A field coil 608 may be wound around each armature 602 to provide excitation.

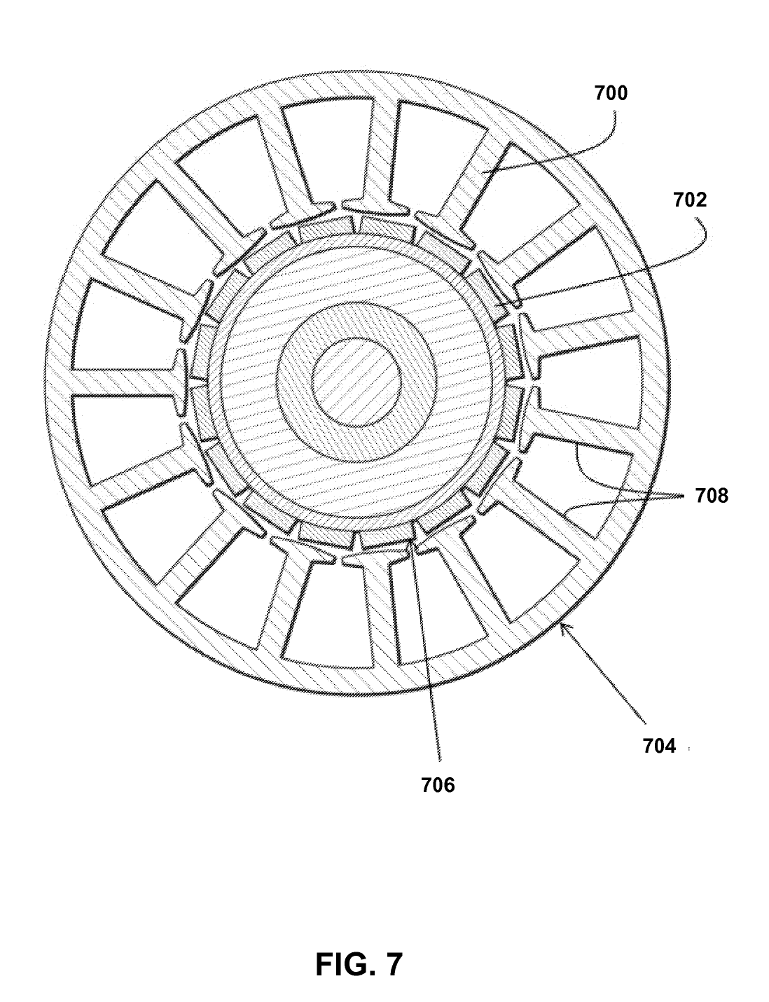

FIG. 7 illustrates an alternative embodiment of a DC motor having tapered stator armature heads 700 facing respective rotor magnets 702. The stator 704 may have at least approximately thirteen armatures, with fifteen armatures in the illustrated embodiment of FIG. 7. The rotor 706 may have at least approximately fourteen permanent magnets, with sixteen magnets in the illustrated embodiment. Opposing walls of adjacent armatures 708 may each be planar and oriented perpendicular to an axis of rotation of the rotor 706. The rotor armatures collectively provide a vector sum magnetic force (F_{V})_{SUM} of zero at every angular rotation position of the rotor with respect to the stator during the rotor's non-energized state to reduce magnetic “cogging.”

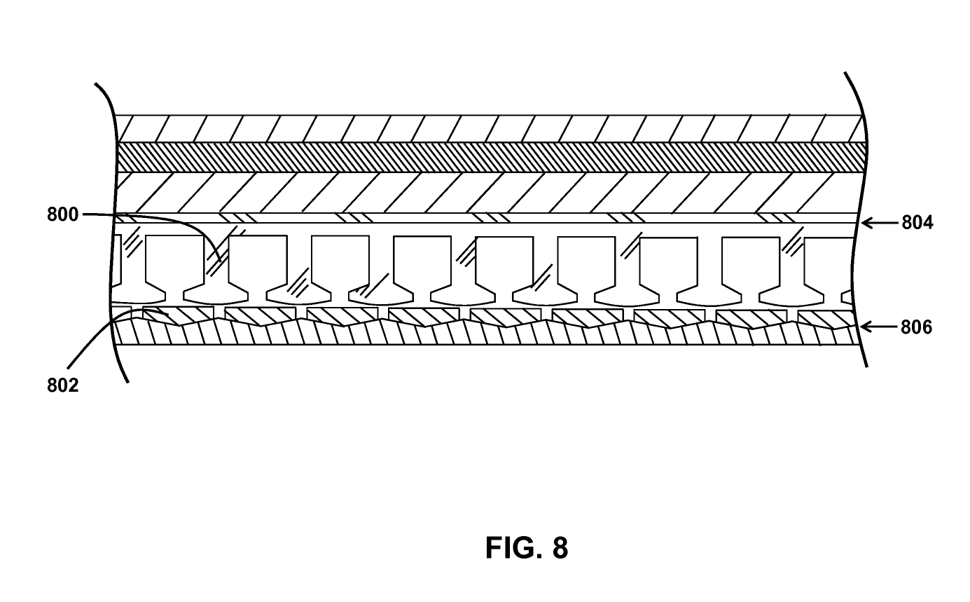

FIG. 8 illustrates one embodiment of a linear DC motor having rotor armatures 800 facing respective stator magnets 802. In this embodiment, the rotor 804 is not concentric with the stator 806, but the rotor and stator are linearly arranged, with the rotor moving in relation to the stator. The rotor armatures 800 collectively provide a vector sum magnetic force (F_{V})_{SUM} of zero at every linear position of the rotor with respect to the stator during the rotor's non-energized state to reduce magnetic “cogging.” In an alternative embodiment, the armatures are stators and the magnets are rotors in a linear arrangement.

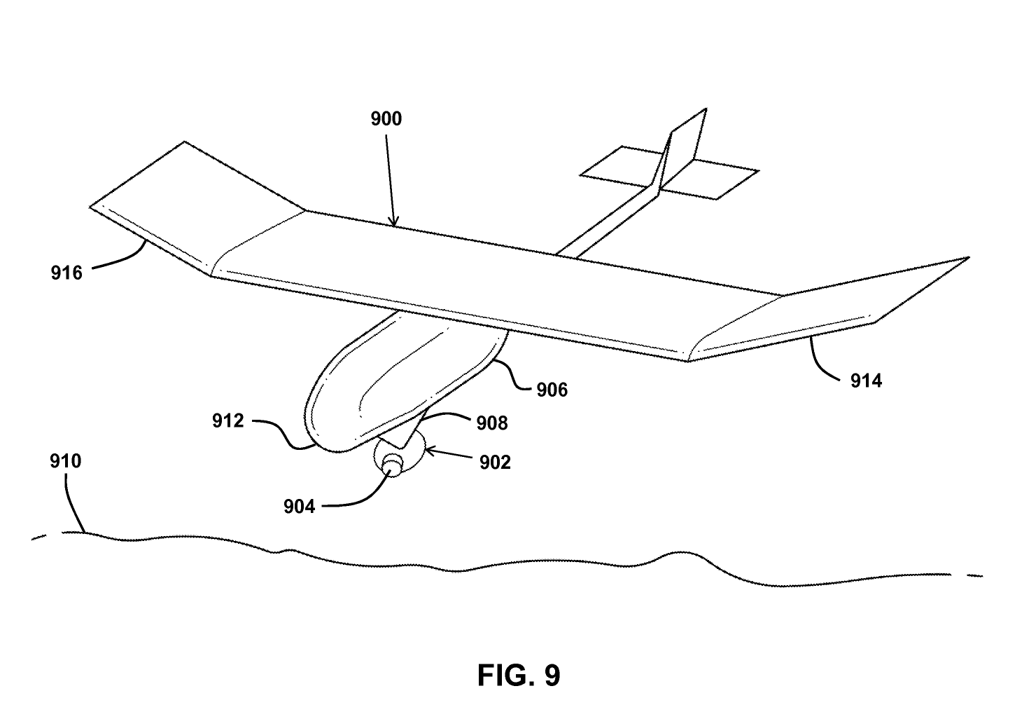

FIG. 9 is a perspective view of an unmanned aerial vehicle (UAV) 900 with an exemplary sensor gimbal 902. The sensor gimbal 902 may comprise a sensor 904, e.g., an imager, coupled to a direct-drive motor (such as that illustrated in FIGS. 1-7), with the motor in a direct-drive configuration with the imager. The sensor gimbal 902 may be coupled to a fuselage 906 of the UAV 900 through a sensor gimbal support 908 to provide an unobstructed view of ground 910, below. In alternative embodiments, the sensor gimbal 902 may be coupled to a front portion 912 of the fuselage 906 to provide an unobstructed view of both the ground 910 and an airspace in front of the UAV 900, or may be one of a plurality of sensor gimbals extending from a bottom surface of port or starboard wings (914, 916).

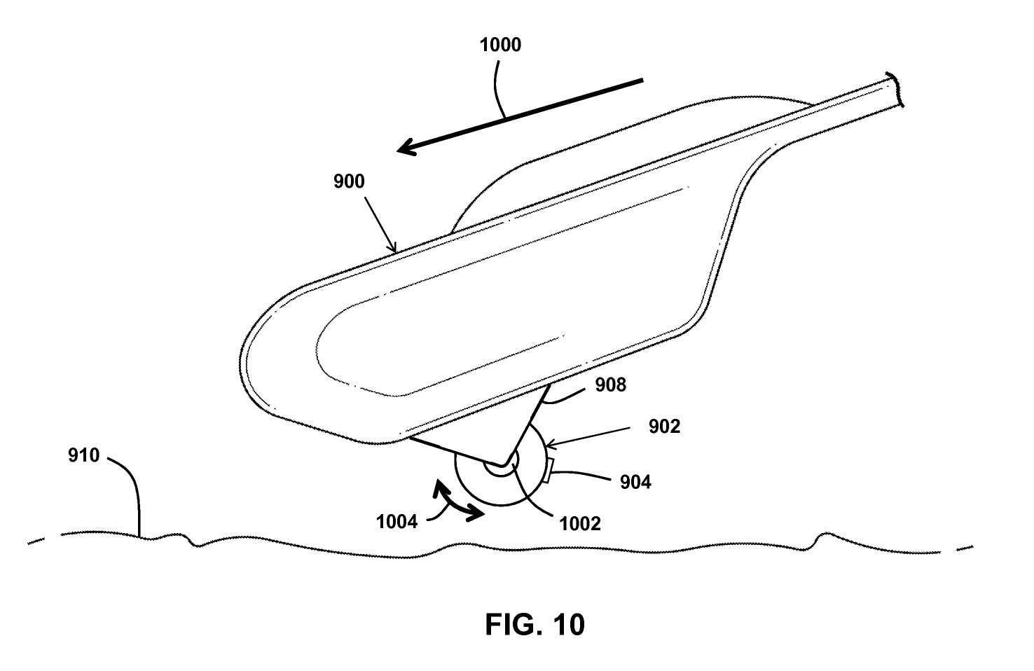

FIG. 10 is a side view of the UAV 900 with the exemplary sensor gimbal 902 approaching the ground 910. In some embodiments, the UAV 900 is a glider or has an electric propulsion system (not shown), and so may have a forward motion 1000 during approach and landing with the ground 910. The sensor gimbal 902 is illustrated having a motor 1002, preferably a direct-drive motor, to rotate the sensor 904 in a direct-drive configuration on the sensor gimbal 902 to a stowed rear-facing angular position 1004 for landing. In an alternative embodiment, the sensor 904 may be rotated to a forward-facing angular position or may remain in an arbitrary or other pre-determined position for landing. As used herein, “direct-drive configuration” means the sensor 904 may be rotatably driven by the motor 1002 without the benefit of reduction gears, cabling and/or belt drives. In one embodiment, the sensor 904 may be coupled to an exterior of the motor 1002, with the motor 1002 rotating around an inner stator fixed to the gimbal support 908. In an alternative embodiment, the sensor 904 may be coupled to a rotatable shaft of the motor via a linkage (not shown). In another alternative embodiment, the sensor 904 may be coupled to two or more motors to provide movement of the sensor 904 in two or more axes (not shown).

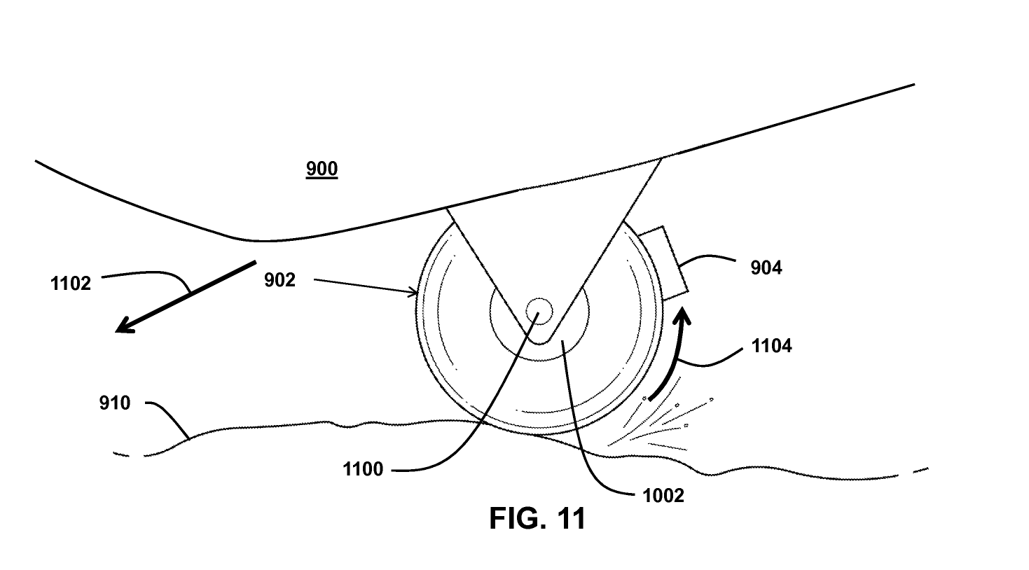

FIG. 11 is a side view of the UAV 900 with the exemplary sensor gimbal 902 making contact with the ground 910. The motor 1002 may have an axis of rotation 1100 to drive the sensor 904 in a direct-drive configuration about the axis of rotation 1100. In an alternate embodiment, the motor may control the movement of the sensor 904 via a linkage connected to a center rotatable shaft of a sensor gimbal (not shown). Upon a landing, where the UAV has a forward motion 1102, the sensor gimbal 902 may experience a strong rotational moment 1104 as the sensor gimbal contacts the ground 910. As one benefit of the direct-drive configuration, the sensor gimbal 902 lacks reduction gears, cabling and/or belt drives otherwise found in prior art sensor assemblies and so strong impacts or other forces on the gimbal will not result in the breaking of gears or the stripping of gears.

The illustrations and examples provided herein are for explanatory purposes and are not intended to limit the scope of the appended claims. This disclosure is to be considered an exemplification of the principles of the invention and is not intended to limit the spirit and scope of the invention and/or claims of the embodiment illustrated. It is contemplated that various combinations and/or sub-combinations of the specific features, systems, methods, and aspects of the above embodiments may be made and still fall within the scope of the invention. Accordingly, it should be understood that various features and aspects of the disclosed embodiments may be combined with or substituted for one another in order to form varying modes of the disclosed invention. Further it is intended that the scope of the present invention herein disclosed by way of examples should not be limited by the particular disclosed embodiments described above.

What is claimed is:

1. A direct current (DC) motor apparatus, comprising:
a stator having a plurality of magnets; and
a rotor having a plurality of armatures, wherein a quantity of the plurality of armatures is less than a quantity of the plurality of magnets, each of the armatures of the plurality of armatures experiencing a vector magnetic force in response to its proximity to respective adjacent magnets of the plurality of magnets, and each of the armatures having a planar sidewall opposing a planar sidewall of an adjacent armature;
wherein the vector sum of magnetic forces between each armature and its respective adjacent magnets of the plurality of magnets is zero at every angular rotation position of the rotor with respect to the stator in the motor's non-energized state.

2. The apparatus of claim 1, wherein each armature of the plurality of armatures comprises:
a forward-tapered end and an aft-tapered end, wherein each of the forward-tapered ends and each of the aft-tapered ends are configured to accept periodic near magnetic saturation as the armature rotates past the respective adjacent magnets of the plurality of magnets.

3. The apparatus of claim 2, wherein each armature of the plurality of armatures has a constant-radius face.

4. The apparatus of claim 3, wherein each magnet of the respective adjacent magnets of the plurality of magnets has a planar face in complementary opposition to the constant-radius face of each armature of the plurality of armatures.

5. The apparatus of claim 3, wherein the stator has between thirteen and nineteen magnets and the rotor has between twelve and eighteen armatures.

6. The apparatus of claim 2, wherein each armature of the plurality of armatures has a complementary face to each magnet of the respective adjacent magnets of the plurality of magnets, each complementary face selected from the group consisting of multi-planar, concave, and convex.

7. The apparatus of claim 2, wherein each armature of the plurality of armatures has a tapered root section.

8. The apparatus of claim 1, wherein the stator further comprises a back iron.

9. The apparatus of claim 8, wherein the back iron has inner angular sidewall portions to align each magnet of the plurality of magnets.

10. The apparatus of claim 1, wherein each magnet of the plurality of magnets is an electromagnet.

11. The apparatus of claim 1, wherein each armature of the plurality of armatures is comprised of alternating layers of a laminated electrical steel layer and an oxide film layer.

12. A DC motor apparatus, comprising:
a stator having a plurality of armatures, each of the armatures having a planar sidewall opposing a planar sidewall of an adjacent armature, and;
a rotor having a plurality of magnets, each of the magnets of the plurality of magnets experiencing a vector magnetic force in response to its proximity to respective adjacent armatures of the plurality of armatures, wherein a quantity of the plurality of magnets is less than a quantity of the plurality of armatures; and
wherein the vector sum of magnetic forces between each magnet and its respective adjacent armatures of the plurality of armatures is zero at every angular rotation position of rotor the with respect to the stator in the non-energized state of the motor.

13. The apparatus of claim 12, wherein each armature of the plurality of armatures comprises:
a forward-tapered end and an aft-tapered end, wherein each of the forward-tapered ends and each of the aft-tapered ends are configured to accept periodic near magnetic saturation as the magnets rotate past the respective adjacent armature of the plurality of armatures.

14. The apparatus of claim 13, wherein each armature of the plurality of armatures has a constant-radius face.

15. The apparatus of claim 14, wherein each magnet of the respective adjacent magnets of the plurality of magnets has a planar face in complementary opposition to the constant-radius face of each armature of the plurality of armatures.

16. The apparatus of claim 14, wherein the stator has between thirteen and nineteen armatures and the rotor has between twelve and eighteen magnets.

17. The apparatus of claim 13, wherein each armature of the plurality of armatures has a complementary face to each magnet of the respective adjacent magnets of the plurality of magnets, each complementary face selected from the group consisting of multi-planar, concave, and convex.

18. The apparatus of claim 13, wherein each armature of the plurality of armatures has a tapered root section.

19. The apparatus of claim 12, wherein the stator further comprises a back iron.

20. The apparatus of claim 19, wherein the back iron has inner angular sidewall portions to align each magnet of the plurality of magnets.

21. The apparatus of claim 12, wherein each magnet of the plurality of magnets is an electromagnet.

22. The apparatus of claim 12, wherein each armature of the plurality of armatures is comprised of alternating layers of a laminated electrical steel layer and an oxide film layer.

23. The apparatus of claim 12, further comprising:
a motor shaft driven by said rotor; and
a sensor rotatably driven by said motor shaft;
wherein the zero vector sum of magnetic forces between each magnet and its respective adjacent armatures results in a “cogless” rotation of the sensor on the motor shaft.

24. A method comprising:
communicating a plurality of magnetic fields between a respective plurality of armatures on a rotor and respective pairs of magnets on a stator for each armature; and
balancing the plurality of magnetic fields about the rotor as the rotor is rotated so that the vector sum of magnetic forces on the plurality of armatures is approximately zero as the rotor is rotated a complete revolution in its non-energized state;
wherein the motor is substantially “cogless” as the rotor turns in its non-energized state.

25. An unmanned aerial vehicle (UAV) sensor apparatus, comprising:
a UAV;
a brushless direct current (DC) motor coupled to the UAV, the DC motor further comprising:
a stator having a plurality of magnets; and
a rotor having a plurality of armatures, wherein a quantity of the plurality of armatures is less than a quantity of the plurality of magnets, each of the armatures of the plurality of armatures experiencing a vector magnetic force in response to its proximity to respective adjacent magnets of the plurality of magnets, and each of the armatures having a planar sidewall opposing a planar sidewall of an adjacent armature;
wherein the vector sum of magnetic forces between each armature and its respective adjacent magnets of the plurality of magnets is zero at every angular rotation position of the rotor with respect to the stator in the motor's non-energized state; and
a sensor coupled to the motor in a direct-drive configuration;
wherein the sensor is driven directly by the motor so that an angular rotation of the rotatable shaft, Δφ, results in the same angular rotation Δφ of the sensor.

26. The apparatus of claim 25, wherein each armature of the plurality of armatures comprises:
a forward-tapered end and an aft-tapered end, wherein each of the forward-tapered ends and each of the aft-tapered ends are configured to accept periodic near magnetic saturation as the armature rotates past the respective adjacent magnets of the plurality of magnets.

27. The apparatus of claim 25, wherein each armature of the plurality of armatures has a face shape selected from the group consisting of multi-planar, concave, and convex.

28. An unmanned aerial vehicle (UAV) sensor apparatus, comprising:
a UAV;
a direct-drive motor coupled to the UAV; and
a sensor coupled to the direct-drive motor, the direct-drive motor configured to angularly drive the sensor.

29. The apparatus of claim 28, wherein the direct-drive motor is coupled to the UAV through a support.
